(19) United States
(12) Patent Application Publication
(10) Pub. No.: US 2013/0113841 A1
(43) Pub. Date: May 9, 2013

(54) BACKLIGHT UNIT AND DISPLAY DEVICE INCLUDING THE SAME

(71) Applicants: Min-Soo CHOI, Asan-si (KR); Moon Shik KANG, Yongin-si (KR); Young Sup KWON, Gwangmyeong-si (KR); Seung Hun HAN, Daejeon (KR)

(72) Inventors: Min-Soo CHOI, Asan-si (KR); Moon Shik KANG, Yongin-si (KR); Young Sup KWON, Gwangmyeong-si (KR); Seung Hun HAN, Daejeon (KR)

(73) Assignees: DS ELECTRON CO., LTD., Hwaseong-si (KR); SAMSUNG ELECTRONICS CO., LTD., Suwon-si (KR)

(21) Appl. No.: 13/438,118

(22) Filed: Apr. 3, 2012

(30) Foreign Application Priority Data
Nov. 8, 2011 (KR) 10-2011-0116084

(51) Int. Cl. G09G 3/32; H05B 37/02; G09G 5/10

(52) U.S. Cl. 345/690; 315/192; 345/82

(57) ABSTRACT

A backlight unit includes: a light source unit including at least one light emitting diode (“LED”) string; a driving current controller which is connected to a cathode terminal of the at least one LED string and controls a driving current which flows through the at least one LED string; a feedback unit which generates a feedback signal based on a dimming input signal and a voltage of the cathode terminal of the at least one LED string; and a direct current to direct current (“DC-DC”) converter which generates a driving voltage in response to the feedback signal and provides the driving voltage to the light source unit.

This application claims priority to Korean Patent Application No. 10-2011-0116084 filed on Nov. 8, 2011, and all the benefits accruing therefrom under 35 U.S.C. §119, the entire contents of which are incorporated herein by reference.

### BACKGROUND OF THE INVENTION

(a) Field of the Invention

The invention relates to a backlight unit and a display device including the same.

(b) Description of the Related Art

Flat panel displays are classified into a self-light-emitting display device that emits its own light to display an image, such as a light emitting diode (“LED”) display device, a field emissive display (“FED”) device, a vacuum fluorescent display (“VFD”) device and a plasma display panel (“PDP”), and a passive (non-emissive) display device that does not emit light itself and requires a light source such as a liquid crystal display (“LCD”) and an electrophoretic display.

The passive display device includes a display panel which displays an image, and a backlight unit (otherwise referred to as a light source unit) providing the light to the display panel. The light source unit includes a light source which generates light. The light source may include, but is not limited to, a cold cathode fluorescent lamp (“CCFL”), a flat fluorescent lamp (“FFL”), and an LED. The LED having low power consumption and generating a small amount of heat is often used as the light source.

### BRIEF SUMMARY OF THE INVENTION

The invention provides a backlight unit where a driving current of a light emitting diode (“LED”) can be promptly changed according to a fast change of a dimming input signal which includes information for luminance of the LED, and a display device including the backlight unit.

An exemplary embodiment of a backlight unit according to the invention includes: a light source unit including at least one LED string; a driving current controller which is connected to a cathode terminal of the at least one LED string and controls a driving current flowing through the LED string; a feedback unit which generates a feedback signal based on a dimming input signal and a voltage of the cathode terminal of the at least one LED string; and a direct current to direct current (“DC-DC”) converter which generates a driving voltage in response to the feedback signal and provides the driving voltage to the light source unit.

An exemplary embodiment of a display device according to the invention includes: a display panel including a plurality of pixels; a light source unit which generates and provides light to the display panel and includes at least one LED string; and a light source driver which drives the light source unit. The light source driver includes a driving current controller which is connected to a cathode terminal of the at least one LED string and controls a driving current flowing through the LED string; a feedback unit which generates a feedback signal based on a dimming input signal and a voltage of the cathode terminal of the at least one LED string; and a DC-DC converter which generates a driving voltage in response to the feedback signal and provides the driving voltage to the light source unit.

The feedback unit may include a first dimming signal converter which converts the dimming input signal according to a first function and generates a conversion dimming signal, at least one diode which is respectively connected to the cathode terminal of the at least one LED string, and a first amplifier which receives the conversion dimming signal and an output voltage of the at least one diode and generates the feedback signal, and inputs the feedback signal to the DC-DC converter.

The first function has an output which decreases according to an increase of the dimming input signal.

The at least one diode of the feedback unit may be connected to a reference voltage via a resistor.

The driving current controller may include a second dimming signal converter which converts the dimming input signal according to a second function and generates a dimming reference signal, a transistor including a drain terminal which connected to the cathode terminal of the at least one LED string, and a second amplifier which receives the dimming reference signal and a voltage of a source terminal of the transistor and generates a control signal, and inputs the control signal to a control terminal of the transistor.

The second function has an output which increases according to an increase of the dimming input signal.

The driving current controller may further include a resistor which is connected to the source terminal of the transistor.

A drain-source voltage of the transistor may increase as the dimming input signal decreases.

According to the exemplary embodiments of the invention, even when a dimming input signal which includes information for luminance of the LED included in a backlight unit is quickly changed from a low luminance to a high luminance, the driving current of the LED may be quickly changed such that operation characteristics of the backlight unit may be improved.

### BRIEF DESCRIPTION OF THE DRAWINGS

The above and other features of this disclosure will become more apparent by describing in further detail exemplary embodiments thereof with reference to the accompanying drawings, in which:

FIG. 1 is a block diagram of an exemplary embodiment of a backlight unit according to an the invention,

FIG. 2 is a circuit diagram of an exemplary embodiment of a direct current to direct current (“DC-DC”) converter of a backlight unit according to the invention,

FIG. 3 and FIG. 4 each are graphs showing an exemplary embodiment of a signal conversion method in a dimming signal converter according to an the invention,

FIG. 5 is a graph of an exemplary embodiment of a change of a driving voltage Vout, a change of a voltage difference V₁₂ between opposing ends of a light emitting diode (“LED”) string, and a change of a voltage difference V₂₃ between a drain terminal voltage and a source terminal voltage of a transistor in volts (V), with respect to a dimming input signal Icon in the backlight unit shown in FIG. 1, and

FIG. 6 is a block diagram of an exemplary embodiment of a display device including a backlight unit according to the invention.

### DETAILED DESCRIPTION OF THE INVENTION

The invention will be described more fully hereinafter with reference to the accompanying drawings, in which exemplary embodiments of the invention are shown. As those skilled in the art would realize, the described embodiments may be modified in various different ways, all without departing from the spirit or scope of the invention.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the invention will be described in detail with reference to the accompanying drawings.

A light source unit using a light emitting diode (“LED”) as a light source includes at least one LED string in which a plurality of LEDs is coupled in series. According to a dimming method (referred to as light control) which controls luminance of the light source unit, the luminance of the light source unit may be controlled by controlling a driving current flowing along the LED string. When the luminance of the light source unit is rapidly changed, the response speed of the light source of the light source unit cannot follow the changing luminance information for the light source such that the luminance control of the light source unit may be delayed.

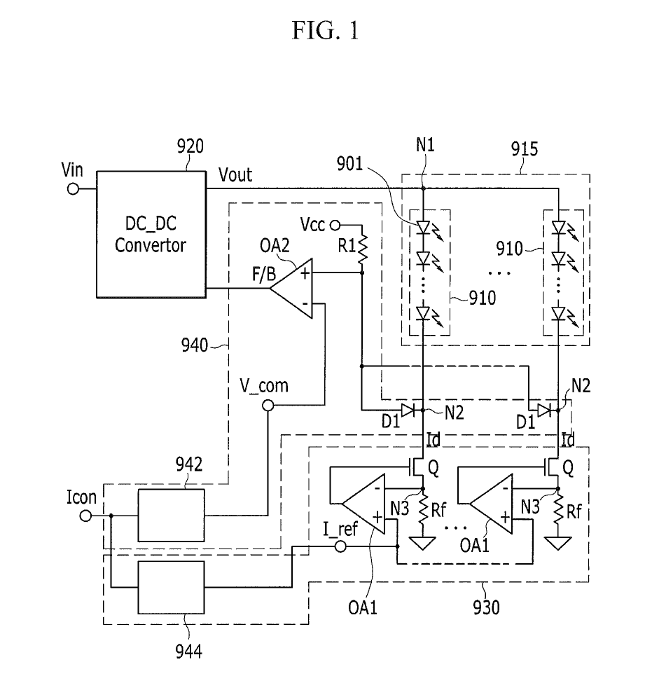

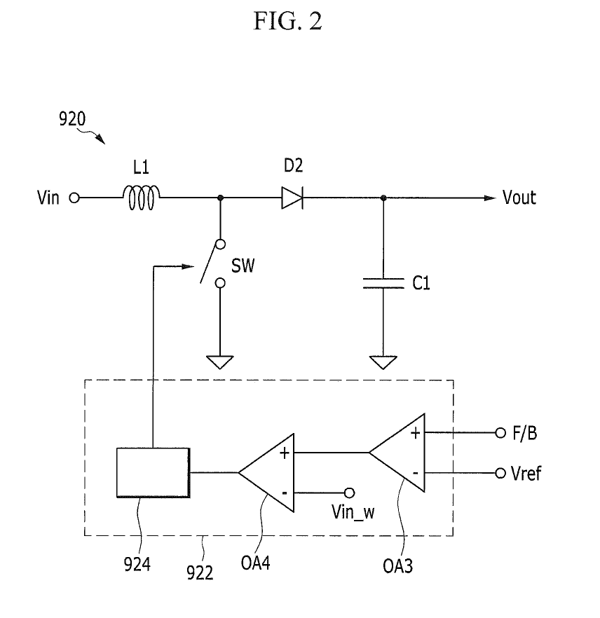

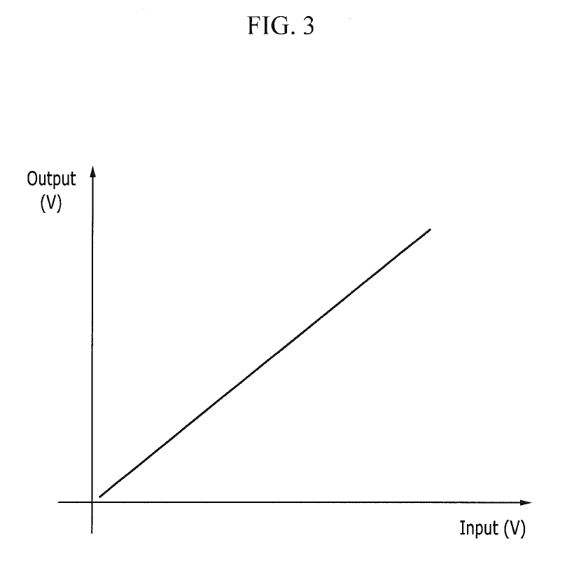

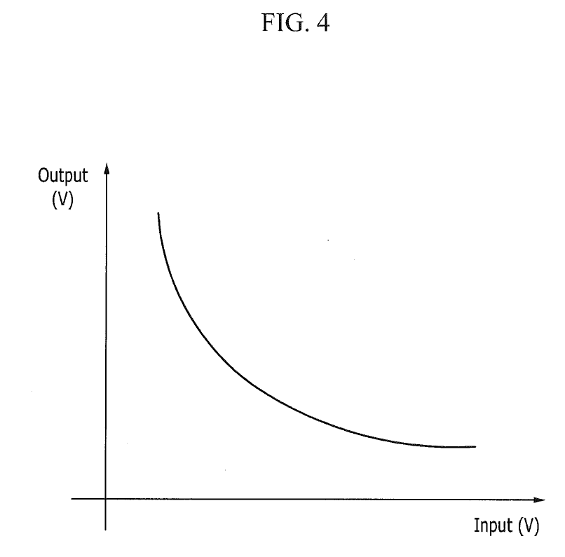

An exemplary embodiment of a backlight unit according to the invention will be described with reference to FIG. 1, FIG. 2, FIG. 3 and FIG. 4.

FIG. 1 is a block diagram of an exemplary embodiment of a backlight unit according to the invention, FIG. 2 is a circuit diagram of an exemplary embodiment of a direct current to direct current (“DC-DC”) converter of a backlight unit according to the invention, and FIG. 3 and FIG. 4 each are graphs showing an exemplary embodiment of a signal conversion method in a dimming signal converter according to the invention.

Referring to FIG. 1, an exemplary embodiment of a backlight unit according to the invention includes a light source unit 915, and a light source driver which drives the light source unit 915.

The light source unit 915 includes at least one LED string 910. The light source unit 915 may include a plurality of LED strings which is coupled in parallel. Each LED string 910 may include a plurality of LEDs 901 which is coupled in series. Each LED string 910 emits light with a luminance due to a driving current according to a voltage difference V₁₂ between an anode terminal N1 of the light source unit 915 at a first end of the LED string 910 and a cathode terminal N2 at an opposing second end of the LED string 910. The voltage difference V₁₂ between terminals of respective LED strings 910 may be different from each other.

The light source driver includes a DC-DC converter 920, a driving current controller 930 and a feedback unit 940.

The DC-DC converter 920 receives an input voltage Vin, generates a driving voltage Vout based on a feedback signal F/B from the feedback unit 940 and transmits the driving voltage Vout to the anode terminal N1 of the light source unit 915.

Referring to FIG. 2, an exemplary embodiment of the DC-DC converter 920 according to the invention may be a boost converter which receives the input voltage Vin of a DC and outputs a driving voltage Vout as a high DC voltage. The DC-DC converter 920 may include an inductor L1, a diode D2, a switching element SW, a capacitor C1 and a controller 922 for the switching element SW. The controller 922 may include an amplifier OA3 including a non-inversion terminal which receives a feedback signal F/B from the feedback unit 940 and an inversion terminal which receives a reference voltage Vref, an amplifier OA4 including a non-inversion terminal which receives an output of the amplifier OA3 and an inversion terminal which receives an input signal Vin_w of a predetermined waveform, and a driver 924 which receives the output of the amplifier OA4 and generates a control signal that is input to the control terminal of the switching element SW. The input signal Vin_w may be a triangular wave. The DC-DC converter 920 generates the driving voltage Vout according to a magnetic energy of an inductor L1 generated due to on/off of the switching element SW which is operated according to the control signal of the controller 922 and the charging energy of the capacitor C1.

Referring to FIG. 1, the driving current controller 930 may include a dimming signal converter 944, at least one transistor Q which is connected to the cathode terminal N2 of each LED string 910, an amplifier OA1 and a resistor Rf.

The dimming signal converter 944 receives the dimming input signal Icon input from the outside and converts it according to a predetermined function to generate a dimming reference signal I_ref, and inputs the dimming reference signal I_ref to the amplifier OA1. The dimming input signal Icon is information for the luminance of the LED 901 of the light source unit 915.

Referring to FIG. 3, an exemplary embodiment of a conversion function to which the dimming signal converter 944 is adapted according to the invention may be a function that has a positive slope of a graph representing an output in volts (V) corresponding to the dimming reference signal I_ref with respect to the input in volts (V) corresponding to the dimming input signal Icon. That is, the dimming reference signal I_ref may have a larger value as the dimming input signal Icon is increased. In one exemplary embodiment, for example, the conversion function of the dimming signal converter 944 may be various functions having the positive slope such as a non-linear function of an exponential function, or a proportional function.

The amplifier OA1 may be a differential amplifier, thereby amplifying a difference between the voltage of the dimming reference signal I_ref and the voltage of the source terminal N3 of the transistor Q. The dimming reference signal I_ref may be input to the non-inversion terminal of the amplifier OA1, and the voltage of the source terminal N3 of the transistor Q may be input to the inversion terminal of the amplifier OA1.

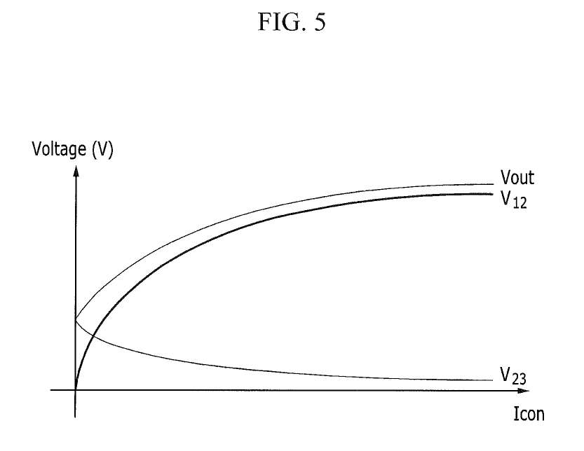

The transistor Q includes a gate terminal connected to the output terminal of the amplifier OA1, a drain terminal connected to the cathode terminal N2 of the LED string 910, and a source terminal connected to the inversion terminal of the amplifier OA1 and the resistor Rf. The transistor Q may be a field effect transistor (“FET”), a bipolar junction transistor (“BJT”), or a Negative-Positive-Negative type (“NPN”) transistor. The transistor Q may be operated in a linear region where a voltage difference V₂₃ (refer to FIG. 5) between a drain terminal voltage and a source terminal voltage of the transistor (also referred to as “drain-source voltage V₂₃”) is also increased when the current Id of the drain terminal is increased.

The resistor Rf is connected between the source terminal N3 of the transistor Q and a reference voltage such as a ground voltage, thereby determining a magnitude of the drain current of the transistor Q, that is, the driving current of the LED 901.

This driving current controller 930 controls the voltage of the cathode terminal N2 of the LED string 910 such that the driving current flowing through the LED string 910 may be controlled to depend on the dimming reference signal I_ref.

Referring to FIG. 1, the feedback unit 940 may include a dimming signal converter 942 which receives the dimming input signal Icon, an amplifier OA2 and at least one diode D1 which is connected to each cathode terminal N2 of a plurality of LED strings 910.

The dimming signal converter 942 receives the dimming input signal Icon and converts it according to a predetermined function to generate a conversion dimming signal V_com. The conversion dimming signal V_com may be input to the inversion terminal of the amplifier OA2.

Referring to FIG. 4, an exemplary embodiment of a conversion function to which the dimming signal converter 942 is adapted according to the invention may be a function that has a negative slope of a graph representing an output in volts (V) corresponding to the conversion dimming signal V_com with respect to the input in volts (V) corresponding to the dimming input signal Icon. That is, the conversion dimming signal V_com may become smaller as the dimming input signal Icon is increased. In one exemplary embodiment, for example, the conversion function of the dimming signal converter 942 may be various functions such as a non-linear function of the exponential function having a negative slope, an inversely proportional function, and a linear function having a negative slope.

The driving current flowing through the LED 901 may be changed according to the temperature of the backlight unit. To compensate the change of the driving current according to the temperature of the backlight unit, the backlight unit may further include a temperature sensor (not shown) sensing the temperature, and the dimming signal converter 942 converts the dimming input signal Icon based on a temperature detection signal from the temperature sensor such that the difference of the driving current according to the temperature change may be compensated.

Referring again to FIG. 1, a diode D1 connected to the cathode terminal N2 of each LED string 910 is commonly connected to the resistor R1 which is connected to a reference voltage Vcc and the non-inversion terminal of the amplifier OA2. Accordingly, a minimum voltage among the voltage of the cathode terminal N2 of the LED string 910 is applied to the non-inversion terminal of the amplifier OA2.

The amplifier OA2 may be the differential amplifier which amplifies the difference between the voltage of the cathode terminal N2 and the voltage of the conversion dimming signal V_com, thereby outputting a feedback signal F/B. The output voltage of the diode D1 connected to the cathode terminal N2 may be input to the non-inversion terminal of the amplifier OA2 and the conversion dimming signal V_com may be input to the inversion terminal of the amplifier OA2. As described above, the DC-DC converter 920 receives the feedback signal F/B from the amplifier OA2 and generates the driving voltage Vout based on the feedback signal F/B.

The driving current controller 930 and the feedback unit 940 may be included in one integrated circuit (“IC”) chip along with the DC_DC converter 920.

FIG. 5 is a graph of an exemplary embodiment of a change of a driving voltage Vout, a change of a voltage difference V₁₂ between ends of an LED string and a change of a drain-source voltage V V₂₃ of a transistor Q in volts (V) with respect to a dimming input signal Icon in the backlight unit shown in FIG. 1.

Referring to FIG. 5, when the dimming input signal Icon is small in the backlight unit shown in FIG. 1, that is, the driving current of the LED 901 is small, the drain-source voltage V₂₃ of the transistor Q has a relatively large value compared with a case that the dimming input signal Icon is large. The drain-source voltage V₂₃ of the transistor Q is gradually decreased as the dimming input signal Icon is increased. In the exemplary embodiment, the drain-source voltage V₂₃ may depend on the inversely proportional function, the linear function having the negative slope or the exponential function having the negative slope. Accordingly, the driving voltage Vout to maintain the voltage difference V₁₂ between terminals of the LED string 910 such that the driving current flows according to the dimming input signal Icon becomes a sum of the voltage difference V₁₂ between terminals of the LED string 910 and the drain-source voltage V₂₃ of the transistor Q.

When the dimming input signal Icon is quickly increased, that is, the luminance of the LED 901 is changed from the low luminance to the high luminance, the driving voltage Vout must be quickly increased. However when the response speed of the DC-DC converter 920 does not follow the quick speed of the dimming input signal Icon, the luminance of the LED 901 may not be changed promptly at a right time according to the dimming input signal Icon. However, in the exemplary embodiment of the invention, the drain-source voltage V₂₃ of the transistor Q in a low luminance region of the dimming input signal Icon has a larger value than in a high luminance region of the dimming input signal Icon such that the voltage difference V₁₂ between terminals of the LED string 910 may be quickly increased through the driving current controller 930 when the dimming input signal Icon is quickly increased. Accordingly, the driving current and the luminance of the LED 901 may be quickly changed according to the dimming input signal Icon. As described above, the driving current of the LED string may be quickly and stably changed for an entire region of the dimming input signal Icon such that the dimming method may be used for a substantially low driving current.

Also, when the driving current of the LED 901 is high, as shown in FIG. 5, the drain-source voltage V₂₃ of the transistor Q is low such that the energy loss in the driving current controller 930 may be reduced.

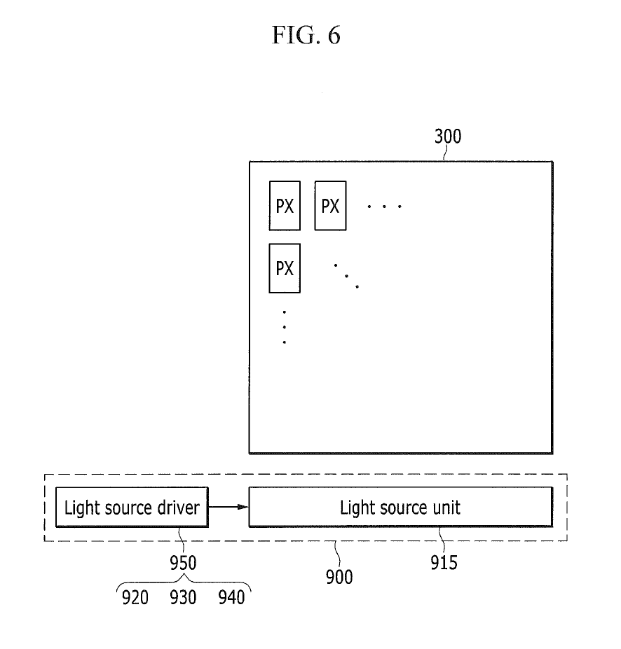

The backlight unit of the described exemplary embodiment may be applied to several passive display devices, such as shown in FIG. 6.

FIG. 6 is a block diagram of an exemplary embodiment of a display device including a backlight unit according to the invention.

Referring to FIG. 6, an exemplary embodiment of a display device according to the invention includes a display panel 300 including a plurality of pixels PX as a unit which displays an image, and the backlight unit 900. The backlight unit 900 includes the light source unit 915 and the light source driver 950 according to the above-described exemplary embodiment. The light source driver 950 includes the DC-DC converter 920, the driving current controller 930 and the feedback unit 940 according to the above-described exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A backlight unit comprising:
a light source unit including at least one light emitting diode string;
a driving current controller which is connected to a cathode terminal of the at least one light emitting diode string and controls a driving current which flows through the at least one light emitting diode string;
a feedback unit which generates a feedback signal based on a dimming input signal and a voltage of the cathode terminal of the at least one light emitting diode string; and
a direct current to direct current converter which generates a driving voltage in response to the feedback signal and provides the driving voltage to the light source unit.

2. The backlight unit of claim 1, wherein
the feedback unit includes:
a first dimming signal converter which converts the dimming input signal according to a first function and generates a conversion dimming signal;
at least one diode which is connected to the cathode terminal of the at least one light emitting diode string; and
a first amplifier which receives the conversion dimming signal and an output voltage of the at least one diode and generates the feedback signal, and inputs the feedback signal to the direct current to direct current converter.

3. The backlight unit of claim 2, wherein
the first function has an output which decreases according to an increase of the dimming input signal.

4. The backlight unit of claim 3, wherein
the at least one diode of the feedback unit is connected to a reference voltage via a resistor.

5. The backlight unit of claim 4, wherein
the driving current controller includes:
a second dimming signal converter which converts the dimming input signal according to a second function and generates a dimming reference signal,
a transistor including a drain terminal which is connected to the cathode terminal of the at least one light emitting diode string; and
a second amplifier which receives the dimming reference signal and a voltage of a source terminal of the transistor and generates a control signal, and inputs the control signal to a control terminal of the transistor.

6. The backlight unit of claim 5, wherein
the second function has an output which increases according to an increase of the dimming input signal.

7. The backlight unit of claim 6, wherein
the driving current controller further includes a resistor which is connected to the source terminal of the transistor.

8. The backlight unit of claim 7, wherein
a drain-source voltage of the transistor increases as the dimming input signal decreases.

9. The backlight unit of claim 1, wherein
the driving current controller includes:
a second dimming signal converter which converts the dimming input signal according to a second function and generates a dimming reference signal,
a transistor including a drain terminal which is connected to the cathode terminal of the at least one light emitting diode string; and
a second amplifier which receives the dimming reference signal and a voltage of a source terminal of the transistor and generates a control signal, and inputs the control signal to a control terminal of the transistor.

10. The backlight unit of claim 9, wherein
the second function has an output which increases according to an increase of the dimming input signal.

11. The backlight unit of claim 10, wherein
the driving current controller further includes a resistor which is connected to the source terminal of the transistor.

12. The backlight unit of claim 11, wherein
a drain-source voltage of the transistor increases as the dimming input signal decreases.

13. A display device comprising:
a display panel including a plurality of pixels;
a light source unit which generates and provides light to the display panel, and includes at least one light emitting diode string; and
a light source driver which drives the light source unit,
wherein the light source driver includes:
a driving current controller which is connected to a cathode terminal of the at least one light emitting diode string and controls a driving current which flows through the light emitting diode string;
a feedback unit which generates a feedback signal based on a dimming input signal and a voltage of the cathode terminal of the at least one light emitting diode string; and
a direct current to direct current converter which generates a driving voltage in response to the feedback signal and provides the driving voltage to the light source unit.

14. The display device of claim 13, wherein
the feedback unit includes:
a first dimming signal converter which converts the dimming input signal according to a first function and generates a conversion dimming signal,
at least one diode which is connected to the cathode terminal of the at least one light emitting diode string, and
a first amplifier which receives the conversion dimming signal and an output voltage of the at least one diode and generates the feedback signal, and inputs the feedback signal to the direct current to direct current converter.

15. The display device of claim 14, wherein
the first function has an output which decreases according to an increase of the dimming input signal.

16. The display device of claim 15, wherein
the at least one diode of the feedback unit is connected to a reference voltage via a resistor.

17. The display device of claim 13, wherein
the driving current controller includes:
a second dimming signal converter which converts the dimming input signal according to a second function and generates a dimming reference signal;
a transistor including a drain terminal which is connected to the cathode terminal of the at least one light emitting diode string; and
a second amplifier which receives the dimming reference signal and a voltage of a source terminal of the transistor and generates a control signal, and inputs the control signal to a control terminal of the transistor.

18. The display device of claim 17, wherein
the second function has an output which increases according to an increase of the dimming input signal.

19. The display device of claim 18, wherein
the driving current controller further includes a resistor which is connected to the source terminal of the transistor.

20. The display device of claim 13, wherein
a drain-source voltage of the transistor increases as the dimming input signal decreases.
